(19) United States
(12) Patent Application Publication
(10) Pub. No.: US 2024/0119551 A1
(43) Pub. Date: Apr. 11, 2024

(54) SYSTEM AND METHOD FOR MAKING SNOW REMOVAL DECISION

(71) Applicant: SAVELIFE INC, Hwaseong-si, Gyeonggi-doo (KR)

(72) Inventor: Suk Jin JUNG, Suwon-si, Gyeonggi-do (KR)

(73) Assignee: SAVELIFE INC, Hwaseong-si, Gyeonggi-do (KR)

(21) Appl. No.: 18/286,370

(22) PCT Filed: Apr. 11, 2022
(86) PCT No.: PCT/KR2022/005178

§ 371 Date: Oct. 11, 2023

(30) Foreign Application Priority Data
Apr. 12, 2021 (KR) 10-2021-0046881

(51) Int. Cl. G06Q 50/26; E01C 23/01

(52) U.S. Cl. CPC G06Q 50/265; E01C 23/01; E01H 10/00

(57) ABSTRACT

The present invention takes into consideration all of three factors causing road freezing 1. the temperature of a road surface; 2. the presence of moisture on the road surface (snowfall, rainfall, dew, fog, and melted water from a snow removal operation, etc.); and 3. the concentration of deicing agents (chlorides) sprayed to prevent freezing, accurately measures these factors, considers interactions among these factors, and predicts when the road is going to freeze over. Therefore, the present invention allows for making accurate decisions on whether to perform snow removal, when to perform snow removal, and the amount of deicing agents to spray, and therefore allows a road manager, regardless of snow removal experience, to make an accurate and quick decision on whether to perform snow removal.

### FIELD OF THE INVENTION

The present invention relates to a system and method for making a snow removal decision.

### DESCRIPTION OF THE RELATED ART

Road freezing is caused by the following three factors and a mutual relationship therebetween.
1. A temperature of a road surface
2. The presence of moisture on a road surface (snowfall, rainfall, dew, fog, melted water from a snow removal operation, or the like)
3. Concentration of deicing agents (chlorides) sprayed to prevent freezing.

In addition, black ice is caused by the following two causes.
1. Instantaneous freezing due to rain on a road surface, such as a bridge, at night or early morning when a temperature of the road surface is low.
2. After a snow removal operation, continued snowfall or rainfall causes a decrease in chloride concentration, resulting in refreezing, or a drop in early morning temperatures causes refreezing.

Black ice is dangerous because it happens suddenly, at a specific point, at a specific time, and road managers have insufficient time to cope with the black ice.

Despite this knowledge of the causes of the road freezing and black ice, there are still a number of major traffic accidents caused by road freezing and black ice every year because of the following reasons.

[Inaccuracy in Measuring Temperature of Road Surface]

In general, the length of roads managed by road managers, such as highways and national roads, is usually 70 km to 500 km, and is usually measured manually by general patrol staff. Nonetheless, it's difficult to accurately measure the surface temperature of all roads, and the measurement of the temperature of the road relies on the atmospheric temperature provided by the meteorological service. However, the temperature of the actual road surface is inevitably inaccurate because a difference between the temperature provided by the meteorological service and the actual temperature of the road surface is very large and changes in real time depending on the material, location, and terrain of the road.

[Difficulty in Measuring Moisture on Road Surface]

Even if the temperature of the road surface is below zero, road freezing only occurs when moisture is supplied from the environment. It is difficult to determine the local snowfall, rainfall, and dew conditions in real time.

[Difficulty in Measuring Deicing Agent (Chlorides) Concentration]

In general, chlorides are applied by spraying salt or calcium chloride after rainfall or snowfall to reduce freezing temperatures. However, only the standard of the spray density of the deicing agent is provided based on foreign standards, but there is no research or data on how much chloride needs to be applied at what temperature during the middle of the snow removal operation.

[Snow Removal Decision Based on Experience of Road Manager]

Currently, the decision on whether to perform snow removal in the event of snowfall or rainfall is made by the person in charge of road management, but the level of snow removal varies greatly depending on the snow removal experience and skill level.

To reduce this variation, snow removal manuals provide approximate chloride spray density (d/g) for each temperature and each amount of snowfall, but it is difficult for road managers to accurately determine the temperature and amount of snowfall on the road surface to determine the amount of snow removal chloride to be applied. The chloride is sprayed at maximum spray density. This increases the cost of snow removal and causes corrosion of bridges due to excessive use of deicing agents. The sprayed deicing agent is blown around the road by vehicle movements, which contaminates the soil around the road.

[Problem with Snow Removal Decision for Preventing Road Surface Refreezing after Snow Removal]

According to the snow removal manual of Korea Expressway Corporation, which manages highways, chloride needs to be applied unconditionally when the temperature is equal to or lower than 4° C. and rain or snowfall occurs. Despite the regulations requiring repeated spraying every two hours after the first spraying, there are still many casualties in traffic accidents caused by poor snow removal operations every year.

It should be noted that the temperature is equal to or lower than 4° C. Initially, the snow removal operation is required to be carried out at a temperature equal to or lower than 2° C., but due to repeated freezing accidents caused by the difference between the actual atmospheric temperature and the temperature of the road surface, the standard for spraying the deicing agents is arbitrarily raised. That is, the temperature of the road surface cannot be collected, and the standard of snow removal needs to be raised, which results in a significant waste of deicing agents.

In addition, the criteria for repeat sprays every two hours after the initial spray is based on manuals to maintain chloride concentrations in preparation for continued snowfall, rainfall, or temperature drops. However, there is no manual for the density of chloride applied or the temperature at which the chloride is applied.

[Problem with Automatic Deicing Agent Spraying Device]

Many automatic spraying devices are currently installed on roads to prevent black ice, but the road manager decides whether or not to activate these devices. However, it is difficult for road managers to recognize the road surface temperature in real-time at the point where the automatic sprayer is installed and to make accurate decisions about how much chloride to apply to the road in the event of snowfall, rainfall, dew, or fog, and how often to repeatedly spray the chloride. For this reason, it is difficult to use the automatic deicing agent spraying device at an appropriate time point.

### DISCLOSURE OF THE INVENTION

### Technical Goals

An object of the present invention is to provide a system and method for making a snow removal decision, which are capable of solving the above-mentioned problems.

### Technical Solutions

In order to achieve the above-mentioned object, a system for making a snow removal decision includes:
an information acquisition unit including a temperature acquisition unit configured to acquire road surface temperature information by measuring a road surface temperature, a moisture acquisition unit configured to acquire road surface moisture information, and a deicing agent concentration acquisition unit configured to acquire road surface deicing agent concentration information by measuring salt concentration of a deicing agent sprayed onto a road surface,
the information acquisition unit being configured to acquire the road surface temperature information, the road surface moisture information, and the road surface deicing agent concentration information on a road; an information monitoring unit including a road surface temperature monitoring unit configured to monitor, in real time, the road surface temperature information on the road, a road surface moisture monitoring unit configured to monitor, in real time, the road surface moisture information on the road, a deicing agent concentration monitoring unit configured to monitor, in real time, the road surface deicing agent concentration information on the road, and a weather information monitoring unit configured to monitor, in real time, weather information on the road provided from the meteorological service or a road weather measurement device, the information monitoring unit being configured to collect and monitor, in real time, the road surface temperature information, road surface moisture information, and road surface deicing agent concentration information on the road acquired by the information acquisition unit and the weather information provided from the meteorological service or the road weather measurement device; and
a decision making unit configured to analyze a monitoring result, predict a risk of freezing on the road surface, and makes a snow removal decision.

The object is achieved by a method of making a snow removal decision, the method including:
a first step including a first-first step of acquiring road surface temperature information by measuring a road surface temperature, a first-second step of acquiring road surface moisture information, and a first-third step of acquiring road surface deicing agent concentration information by measuring salt concentration of a deicing agent sprayed onto a road surface in order to acquire the road surface temperature information, the road surface moisture information, and the road surface deicing agent concentration information on a road;
a second step including a second-first step of monitoring, in real time, the road surface temperature information on the road, a second-second step of monitoring, in real time, the road surface moisture information on the road, a second-third step of monitoring, in real time, the road surface deicing agent concentration information on the road, and a second-fourth step of monitoring, in real time, weather information on the road provided from a meteorological service or a road weather measurement device in order to collect and monitor, in real time, the acquired road surface temperature information, road surface moisture information, and road surface deicing agent concentration information on the road and the weather information provided from the meteorological service or the road weather measurement device; and
a third step including a third-first step of analyzing a monitoring result, determining a risk of freezing on the road surface, and predicting a road surface freezing position and a freezing time point, a third-second step of notifying a driver and road manager of the predicted freezing risk, a third-third step of determining a snow removal timing and a deicing agent spraying density on the road on which the freezing risk has been predicted on the basis of the predicted freezing risk result, and a third-fourth step of monitoring, in real time, a snow removal state of the road in order to analyze the monitoring result, predict the risk of freezing on the road surface, and make a snow removal decision.

### Advantageous Effects

The present invention takes into consideration all of three factors causing road freezing: 1. the temperature of a road surface; 2. the presence of moisture on the road surface (snowfall, rainfall, dew, fog, and melted water from a snow removal operation, etc.); and 3. the concentration of deicing agents (chlorides) sprayed to prevent freezing, accurately measures these factors, considers interactions among these factors, and predicts when the road is going to freeze over. Therefore, the present invention allows for making accurate decisions on whether to perform snow removal, when to perform snow removal, and the amount of deicing agents to spray, and therefore allows a road manager, regardless of snow removal experience, to make an accurate and quick decision on whether to perform snow removal.

The present invention may monitor, in real time, the atmospheric temperature, the road surface temperature, the road surface moisture, and the road surface deicing agent concentration and analyze the road surface temperature drop data according to the atmospheric temperature drop, thereby predicting the accurate freezing and refreezing time point and providing the deicing agent spraying density for preventing the road surface temperature drop. In addition, it is possible to prevent an increase in snow removal costs caused by incorrect and uneven deicing agent spraying, prevent corrosion of the bridge caused by the use of the excessive amount of deicing agents, and prevent contamination of soil around the road caused by the scattering of the sprayed deicing agents around the road by the movement of the vehicle.

### BRIEF DESCRIPTION OF THE DRAWINGS

FIG. 1 is a block diagram illustrating a system for making a snow removal decision according to a first embodiment of the present invention;

FIG. 2 is a view illustrating a state in which an information acquisition unit illustrated in FIG. 1 is installed on a road;

FIG. 3 is a view illustrating a state in which a temperature acquisition unit and a deicing agent concentration acquisition unit of a system for making a snow removal decision according to a second embodiment of the present invention are installed on a vehicle;

FIG. 4 is a flowchart illustrating a method of making a snow removal decision by means of the system for making a snow removal decision according to the first or second embodiment of the present invention;

FIG. 5 is a block diagram of the method of making a snow removal decision illustrated in FIG. 4;

FIG. 6 is a view illustrating an algorithm for determining a freezing risk illustrated in FIG. 5;

FIG. 7 is a table comparing an actual air temperature of a bridge section and a road surface temperature measured at the midpoint of the Chupungnyeong Bridge on the highway (the measurement point of the meteorological service is located at the north end of the Chupungnyeong service area) from 21:00 on Dec. 6, 2016 to 05:00 on Dec. 7, 2016;

FIG. 8 is a table illustrating freezing temperatures for respective concentrations of deicing agents (salt solution, calcium chloride solutions);

FIG. 9 is a view illustrating freezing temperature data according to the deicing agent spraying density when the amount of snowfall is 1 cm; and

FIG. 10 is a view illustrating an exemplary state of snow removal state monitoring.

### DETAILED DESCRIPTION OF THE PREFERRED EMBODIMENT

Hereinafter, a system for making a snow removal decision according to a first embodiment of the present invention will be described in detail.

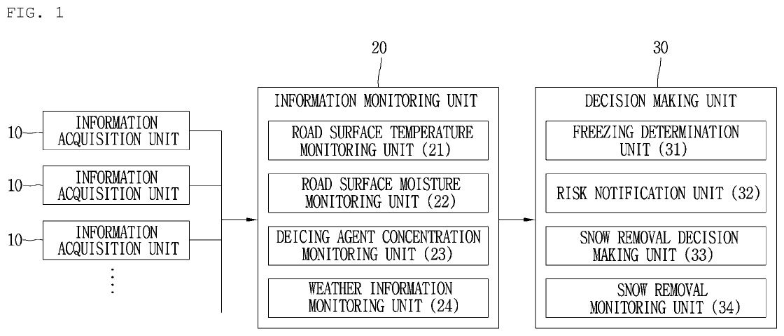

As illustrated in FIG. 1, the system for making a snow removal decision according to the embodiment of the present invention includes information acquisition units 10, an information monitoring unit 20, and a decision making unit 30.

[Information Acquisition Unit 10]

The information acquisition units 10 are installed on roads. The information acquisition unit 10 acquires road surface temperature information, road surface moisture information, and road surface deicing agent concentration information on the roads. The road surface temperature information, the road surface moisture information, and the road surface deicing agent concentration information, which are acquired by the information acquisition unit 10, are transferred to the information monitoring unit 20, which will be described below, together with measurement position information and measurement time information, by using CCTV power sources or the IoT (Internet of Things) installed on the roads.

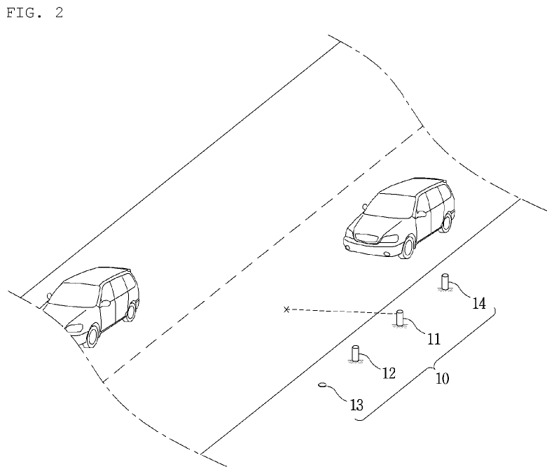

As illustrated in FIG. 2, the information acquisition unit 10 includes a temperature acquisition unit 11, a moisture acquisition unit 12, and a deicing agent concentration acquisition unit 13. The information acquisition units 10 are installed at predetermined intervals on an edge of the road.

Temperature Acquisition Unit 11

The temperature acquisition unit 11 acquires road surface temperature information by measuring a road surface temperature.

The temperature acquisition unit 11 includes a contact temperature sensor installed on the road surface, and a contactless infrared or optical temperature sensor installed on the edge of the road surface. The temperature acquisition unit 11 may further include an atmospheric temperature sensor, and the atmospheric temperature sensor may directly measure an atmospheric temperature around the road independently of an atmospheric temperature provided by the meteorological service. The temperature acquisition unit 11 may acquire more accurate atmospheric temperatures around the road by directly measuring the atmospheric temperature around the road.

Moisture Acquisition Unit 12

The moisture acquisition unit 12 acquires the road surface moisture information by detecting rainwater, snow, fog, dew, frost, and the like. The road surface temperature needs to be below zero and moisture needs to be supplied around the road to cause road freezing. The moisture around the road may be generated by rainwater, snow, fog, dew, frost, and the like.

The moisture acquisition unit 12 has one or more of a rainfall sensor, a snowfall sensor, a fog sensor, a dew sensor, a humidity sensor, and an image capturing device. A CCTV installed on the existing road may be used as the image capturing device, or the image capturing device may be configured by installing an additional sensor on the CCTV.

Deicing Agent Concentration Acquisition Unit 13

In general, a road is paved at a lower level on the edges than on the inside thereof. Therefore, the deicing agents sprayed onto the inside of the road encounter moisture, dissolve, and flow down to the edges. Therefore, the deicing agent concentration acquisition unit 13 may be installed on the edge of the road and measure a salt concentration of the deicing agent. The deicing agent concentration acquisition unit 13 includes an electrical or optical salt sensor.

In general, salt or calcium chloride is used as the deicing agent. The deicing agent concentration acquisition unit 13 acquires the road surface deicing agent concentration information by measuring the salt concentration of the deicing agent sprayed onto the road surface. The salt concentration of the deicing agent is not measured during an initial snow removal process, but the salt concentration of the deicing agent is measured after the snow removal operation is performed. The salt concentration of the deicing agent is used as important information for predicting and determining a refreezing temperature of ice or snow melted by the deicing agent.

[Information Monitoring Unit 20]

The information monitoring unit 20 collects and monitors, in real time, the road surface temperature information, the road surface moisture information, and the road surface deicing agent concentration information on the road acquired by the information acquisition unit 10 and the weather information provided from the meteorological service or a road weather information measurement device.

The information monitoring unit 20 includes a road surface temperature monitoring unit 21, a road surface moisture monitoring unit 22, a deicing agent concentration monitoring unit 23, and a weather information monitoring unit 24.

Road Surface Temperature Monitoring Unit 21

The road surface temperature monitoring unit 21 monitors, in real time, the road surface temperature information at each point on the road. The road surface temperature monitoring unit 21 creates a thermal map from the road surface temperature information. It is possible to easily recognize, in real time, a change in road surface temperature by means of the thermal map.

Meanwhile, in order to acquire the road surface temperatures at all the points in the management section in more detail, the road surface temperature monitoring unit 21 is mounted on the vehicle, obtains road surface temperature information on the entire section of the road, and creates the thermal map, as in a second embodiment to be described below.

Meanwhile, as illustrated in FIG. 7, sections such as bridges often experience rapid temperature drops due to differences in radiant energy emitted by wind or weather, which results in a great difference between the atmospheric temperature and the road surface temperature. Therefore, the real-time monitoring is particularly important.

Road Surface Moisture Monitoring Unit 22

The road surface moisture monitoring unit 22 monitors, in real time, the road surface moisture information on the road.

Deicing Agent Concentration Monitoring Unit 23

The deicing agent concentration monitoring unit 23 monitors, in real time, the road surface deicing agent concentration information on the road.

Weather Information Monitoring Unit 24

The weather information monitoring unit 24 monitors a road surface status by receiving, in real time, the road surface status from a weather information device installed on the road. The weather information from the meteorological service includes information on weather states such as atmospheric temperature, atmospheric humidity, snowfall, rainfall, fog, dew, frost, and the like.

In addition, the weather information monitoring unit 24 may also receive information from the road surface temperature monitoring unit, the road surface moisture monitoring unit, the deicing agent concentration monitoring unit, and the like as well as the weather information device and create a road surface status indication map that indicates the road surface status of the entire section of the road in the map.

That is, the weather information monitoring unit 24 creates the road surface status indication map to allow the road manager to recognize, at a glance, the current road surface status such as road surface dryness, road surface moisture, slush (water+ice), deposited snow, and freezing, such that the road manager may recognize, at a glance, all road situations of the management section and direct workers to perform snow removal in a section in which snow removal is insufficient.

[Decision Making Unit 30]

The decision making unit 30 analyzes the monitoring result, predicts a risk of freezing on the road surface, and makes a decision on the snow removal operation.

The decision making unit 30 includes a freezing determination unit 31, a risk notification unit 32, a snow removal decision making unit 33, and a snow removal monitoring unit 34.

Freezing Determination Unit 31

The freezing determination unit 31 analyzes a monitoring result, determines a risk of freezing on the road surface, and predicts a road surface freezing position and a freezing time point.

Risk Notification Unit 32

The risk notification unit 32 notifies a driver and a road manager of the predicted freezing risk.

Snow Removal Decision Making Unit 33

The snow removal decision making unit 33 determines the snow removal timing and the deicing agent spraying density on the road on which the freezing risk has been predicted on the basis of the result of the freezing determination unit 31.

Snow Removal Monitoring Unit 34

The snow removal monitoring unit 34 monitors, in real time, a snow removal state of the road.

Hereinafter, a system for making a snow removal decision according to a second embodiment of the present invention will be described in detail.

There is a difference in that the temperature acquisition unit 11 and the deicing agent concentration acquisition unit 13 of the information acquisition unit 10 of the system for making a snow removal decision according to the first embodiment are fixedly installed on the road, whereas a temperature acquisition unit 111 and a deicing agent concentration acquisition unit 113 according to the system for making a snow removal decision according to the present embodiment are installed on the vehicle.

Hereinafter, only the temperature acquisition unit 111 and the deicing agent concentration acquisition unit 113, which are different from those of the first embodiment, will be described.

Temperature Acquisition Unit 111

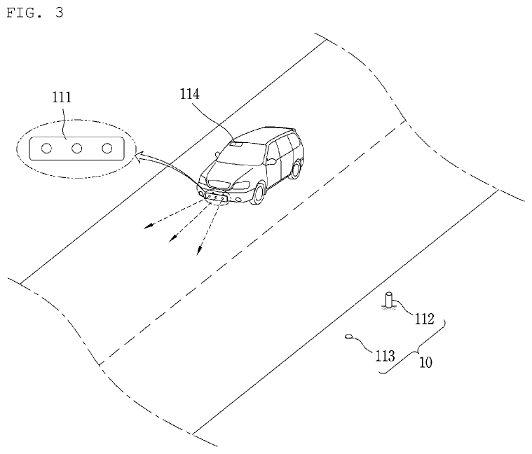

As illustrated in FIG. 3, the temperature acquisition unit 111 is installed on the vehicle. Particularly, the temperature acquisition unit 111 is installed on a front or rear surface of the vehicle. The temperature acquisition unit 111 is configured as a contactless infrared or optical temperature sensor. The temperature acquisition unit 111 may be provided as a plurality of temperature acquisition units 111. The temperature acquisition unit 111 may continuously measure road surface temperatures for respective points while the vehicle travels on the road, such that a temperature map of the road, i.e., a thermal map may be created in more detail in comparison with the first embodiment.

Deicing Agent Concentration Acquisition Unit 113

The deicing agent concentration acquisition unit 113 is installed on the vehicle. Particularly, the deicing agent concentration acquisition unit 113 may be installed on the front or rear surface of the vehicle. The deicing agent concentration acquisition unit 113 includes an electrical or optical salt sensor. The deicing agent concentration acquisition unit 113 may be provided as a plurality of deicing agent concentration acquisition units 113. The deicing agent concentration acquisition unit 113 continuously measures the road surface deicing agent concentration for respective points while the vehicle travels on the road.

An intercity bus, intracity bus, truck, or separate patrol car may be used as the vehicle. The vehicle is equipped with a global positioning system (GPS) to acquire measurement location information.

The measured location information, road surface temperature information, and salt concentration information are transmitted to the monitoring unit by using Wifi, 4G, 5G, and IoT networks, and may also be displayed as a deicing status indication map (DSIM) for the entire road.

Because the temperature acquisition unit 111 and the deicing agent concentration acquisition unit 113 are installed on the vehicle as described above, the road surface temperature and the road surface deicing agent concentration on the entire section of the road to be managed, instead of a particular point, may be continuously and widely measured. Non-described reference numeral 112 indicates the moisture acquisition unit.

Hereinafter, a method of making a snow removal decision by means of the system for making a snow removal decision according to the first or second embodiment of the present invention. FIGS. 1 to 3 will be basically referenced.

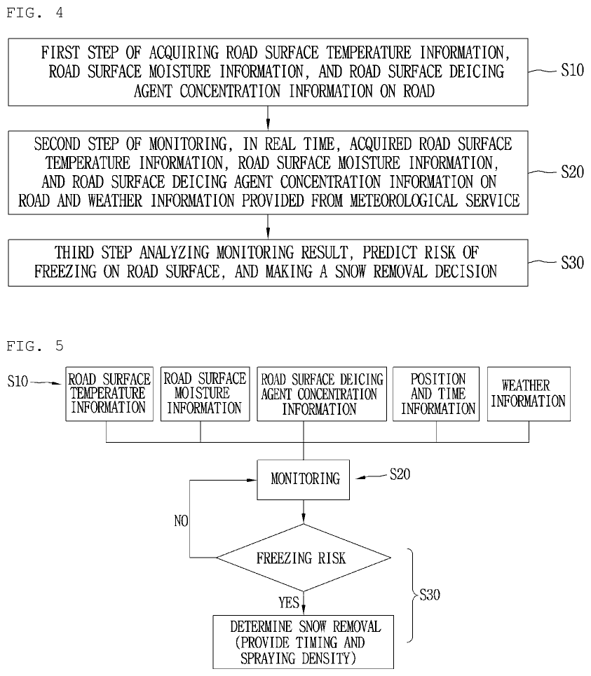

As illustrated in FIGS. 4 and 5, the method of making a snow removal decision includes:
a first step S10 of acquiring road surface temperature information, road surface moisture information, and road surface deicing agent concentration information on the road;
a second step S20 of collecting and monitoring, in real time, the acquired road surface temperature information, road surface moisture information, and road surface deicing agent concentration information on the road and weather information provided from the meteorological service or a road weather information measurement device; and
a third step S30 of analyzing a monitoring result, predicting a risk of freezing on the road surface, and making a decision on the snow removal.

Hereinafter, the first step S10 will be described.

The road surface temperature information, the road surface moisture information, and the road surface deicing agent concentration information on the roads are acquired.

The first step includes:
a first-first step of acquiring the road surface temperature information by measuring the road surface temperature;
a first-second step of acquiring the road surface moisture information by detecting rainwater, snow, fog, dew, frost, and the like; and
a first-third step of acquiring the road surface deicing agent concentration information by measuring salt concentration of the deicing agent sprayed onto the road surface.

Hereinafter, the second step S20 will be described.

The acquired road surface temperature information, road surface moisture information, and road surface deicing agent concentration information on the road and the weather information provided from the meteorological service are collected and monitors in real time. The weather information from the meteorological service or the road weather information measurement device includes information on weather states such as atmospheric temperature, atmospheric humidity, snowfall, rainfall, fog, dew, frost, and the like.

The second step includes:
a second-first step of monitoring, in real time, the road surface temperature information on the road;
a second-second step of monitoring, in real time, the road surface moisture information on the road;
a second-third step of monitoring, in real time, the road surface deicing agent concentration information on the road; and
a second-fourth step of monitoring, in real time, the weather information on the road provided from the meteorological service or the road weather information measurement device.

In the second-first step, a thermal map is created by indicating the road surface temperature information for the entire section of the road on the road map (thermal map).

Hereinafter, the third step S30 will be described.

The monitoring result is analyzed, a risk of freezing on the road surface is predicted, and a decision on the snow removal operation is made.

The third step includes:
a third-first step of analyzing the monitoring result, determining a risk of freezing on the road surface, and predicting a road surface freezing position and a freezing time point;
a third-second step of notifying the driver and road manager of the predicted freezing risk;
a third-third step of determining a snow removal timing and deicing agent spraying density on the road on which the freezing risk has been predicted on the basis of the predicted freezing risk; and
a third-fourth step of monitoring, in real time, a snow removal state of the road.

Third-First Step

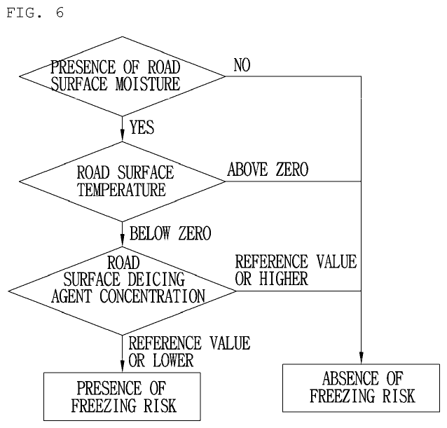

As illustrated in FIG. 6, when moisture on the road surface is detected in a state in which the road surface temperature is below zero and the deicing agent concentration is not detected because the snow removal operation is not yet performed, the road is determined as a freezing risk road.

In addition, when the moisture on the road surface is detected and the snow removal operation is already performed in the state in which the road surface temperature is below zero, the road is determined as the freezing risk road when the detected deicing agent concentration is equal to or lower than a reference value measured in advance.

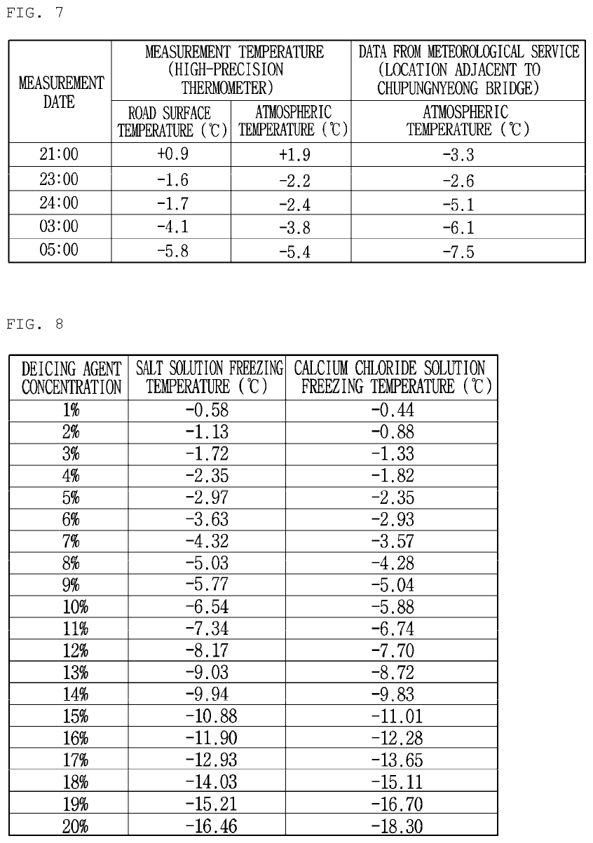

As illustrated in FIG. 8, when the deicing agent is a salt solution in the state in which the moisture on the road surface is detected, freezing does not occur at a temperature higher than −4.32° C. when the concentration is 7%. Meanwhile, when the deicing agent is a calcium chloride solution, freezing does not occur at a temperature higher than −3.57° C. when the concentration is 7%. Therefore, when the deicing agent concentration is known, it is necessary to unconditionally spray the deicing agent again even though the temperature is below zero.

In addition, it is possible to accurately predict the freezing time point of the road by measuring the temperature, moisture, and deicing agent concentration of the road surface.

Third-Second Step

The driver, who passes through the road determined as the freezing risk road, or the road manager, who manages the road, is notified of the freezing risk. The driver or road manager may be notified of the freezing risk by means of an intelligent transport system (ITS) facility.

Third-Third Step

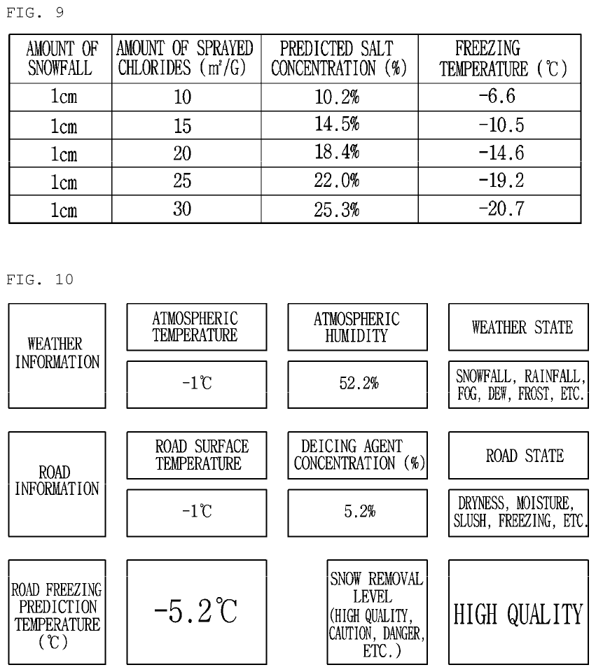

The snow removal (freezing risk) timing and the deicing agent spraying density are determined on the road on which the freezing risk has been predicted on the basis of the predicted result of the freezing risk. The timing of the snow removal operation is determined on the basis of whether a risk of freezing on the road surface occurs and the freezing prediction time point determined in the third-first step. In addition, the spraying density of the deicing agent required to prevent freezing in the predicted state is determined. The spraying density of the deicing agent is determined on the basis of reference data measured in advance. For example, as illustrated in FIG. 9, the spraying density of the deicing agent is determined on the basis of the freezing temperature data according to the deicing agent spraying density when the amount of snowfall is 1 cm.

Third-Fourth Step

When the snow removal timing and the deicing agent spraying density are determined in the third-third step, the snow removal timing and the deicing agent spraying density are transmitted to a snow removal system installed on the road, such that the snow removal operation is performed. When the snow removal operation is performed, the snow removal state of the road is monitored in real time, as illustrated in FIG. 10. Of course, various monitoring methods may be implemented. The snow removal timing and the deicing agent spraying density are determined by the above-mentioned method, such that the accurate snow removal operation may be performed regardless of the experience and skill level of the road manager.

1. A system for making a snow removal decision, the system comprising:
an information acquisition unit including a temperature acquisition unit configured to acquire road surface temperature information by measuring a road surface temperature, a moisture acquisition unit configured to acquire road surface moisture information, and a deicing agent concentration acquisition unit configured to acquire road surface deicing agent concentration information by measuring salt concentration of a deicing agent sprayed onto a road surface, the information acquisition unit being configured to acquire the road surface temperature information, the road surface moisture information, and the road surface deicing agent concentration information on a road;
an information monitoring unit including a road surface temperature monitoring unit configured to monitor, in real time, the road surface temperature information on the road, a road surface moisture monitoring unit configured to monitor, in real time, the road surface moisture information on the road, a deicing agent concentration monitoring unit configured to monitor, in real time, the road surface deicing agent concentration information on the road, and a weather information monitoring unit configured to monitor, in real time, weather information on the road provided from the meteorological service or a road weather information measurement device, the information monitoring unit being configured to collect and monitor, in real time, the road surface temperature information, road surface moisture information, and road surface deicing agent concentration information on the road acquired by the information acquisition unit and the weather information provided from the meteorological service or the road weather information measurement device; and
a decision making unit configured to analyze a monitoring result, predict a risk of freezing on the road surface, and makes a snow removal decision.

2. The system of claim 1, wherein the information acquisition units are installed at predetermined intervals on the road.

3. The system of claim 1, wherein the temperature acquisition unit is installed on a vehicle and continuously measures the road surface temperature by means of an infrared or optical temperature sensor when the vehicle moves.

4. The system of claim 1, wherein the road surface temperature monitoring unit creates a thermal map by indicating the road surface temperature information for an entire section of the road on a road map.

5. The system of claim 1, wherein the deicing agent concentration acquisition unit is installed on a vehicle and continuously measures salt concentration when the vehicle moves.

6. The system of claim 5, wherein the deicing agent concentration acquisition unit includes an electrical or optical salt sensor.

7. The system of claim 1, wherein the weather information monitoring unit creates a road surface status indication map for indicating a road surface status for an entire section of the road.

8. A system for making a snow removal decision, the system comprising:
an information acquisition unit including a temperature acquisition unit configured to acquire road surface temperature information by measuring a road surface temperature, a moisture acquisition unit configured to acquire road surface moisture information, and a deicing agent concentration acquisition unit configured to acquire road surface deicing agent concentration information by measuring salt concentration of a deicing agent sprayed onto a road surface, the information acquisition unit being configured to acquire the road surface temperature information, the road surface moisture information, and the road surface deicing agent concentration information on a road;
an information monitoring unit including a road surface temperature monitoring unit configured to monitor, in real time, the road surface temperature information on the road, a road surface moisture monitoring unit configured to monitor, in real time, the road surface moisture information on the road, a deicing agent concentration monitoring unit configured to monitor, in real time, the road surface deicing agent concentration information on the road, and a weather information monitoring unit configured to monitor, in real time, weather information on the road provided from the meteorological service or a road weather information measurement device, the information monitoring unit being configured to collect and monitor, in real time, the road surface temperature information, road surface moisture information, and road surface deicing agent concentration information on the road acquired by the information acquisition unit and the weather information provided from a meteorological service or the road weather information measurement device; and
a decision making unit configured to consider all three factors of road freezing, i.e., 1. a temperature of the road surface, 2. the presence of moisture on the road surface (snowfall, rainfall, dew, fog, and melted water from a snow removal operation), and 3. concentration of a deicing agent (chloride) sprayed to prevent freezing, the decision making unit being configured to make a snow removal decision by:
determining that the road is not a freezing risk road when moisture on the road surface is not detected in a state in which a road surface temperature is below zero;
determining that the road is the freezing risk road when moisture on the road surface is detected and deicing agent concentration is not detected because a snow removal operation is not yet performed in the state in which the road surface temperature is below zero;
determining that the road is not the freezing risk road when moisture on the road surface is detected, the snow removal operation is already performed in the state in which the road surface temperature is below zero, and the detected deicing agent concentration is equal to or higher than a reference value measured in advance; and
determining that the road is the freezing risk road when moisture on the road surface is detected, the snow removal operation is already performed in the state in which the road surface temperature is below zero, and the detected deicing agent concentration is equal to or lower than the reference value measured in advance,
wherein the deicing agent concentration acquisition unit creates a deicing status indication map for an entire section of the road when the deicing agent concentration acquisition unit installed on a vehicle continuously measures salt concentration when the vehicle moves.

9. A method of making a snow removal decision, the method comprising:
a first step including a first-first step of acquiring road surface temperature information by measuring a road surface temperature, a first-second step of acquiring road surface moisture information, and a first-third step of acquiring road surface deicing agent concentration information by measuring salt concentration of a deicing agent sprayed onto a road surface in order to acquire the road surface temperature information, the road surface moisture information, and the road surface deicing agent concentration information on a road;
a second step including a second-first step of monitoring, in real time, the road surface temperature information on the road, a second-second step of monitoring, in real time, the road surface moisture information on the road, a second-third step of monitoring, in real time, the road surface deicing agent concentration information on the road, and a second-fourth step of monitoring, in real time, weather information on the road provided from a meteorological service or a road weather information measurement device in order to collect and monitor, in real time, the acquired road surface temperature information, road surface moisture information, and road surface deicing agent concentration information on the road and the weather information provided from the meteorological service or the road weather information measurement device; and
a third step including a third-first step of analyzing a monitoring result, determining a risk of freezing on the road surface, and predicting a road surface freezing position and a freezing time point, a third-second step of notifying a driver and road manager of the predicted freezing risk, a third-third step of determining a snow removal timing and a deicing agent spraying density on the road on which the freezing risk has been predicted on the basis of the predicted freezing risk result, and a third-fourth step of monitoring, in real time, a snow removal state of the road in order to analyze the monitoring result, predict the risk of freezing on the road surface, and make a snow removal decision.

10. (canceled)
